(19) United States
(12) Patent Application Publication
(10) Pub. No.: US 2010/0131385 A1
(43) Pub. Date: May 27, 2010

(54) SYSTEMS AND METHODS FOR DISTRIBUTION OF DIGITAL MEDIA CONTENT UTILIZING VIRAL MARKETING OVER SOCIAL NETWORKS

(75) Inventors: Jeffrey Paul Harrang, Sammammish, WA (US); David B. Gibbons, Redmond, WA (US); John M. Burnette, Seattle, WA (US)

Correspondence Address: Davis Wright Tremaine;c/o: Mary Dougherty, Suite 2200, 1201 Third Avenue, Seattle, WA, 98101, US

(73) Assignee: OPANGA NETWORKS, LLC, Seattle, WA (US)

(21) Appl. No.: 12/626,231

(22) Filed: Nov. 25, 2009

Related U.S. Application Data
(60) Provisional application No. 61/117,629, filed on Nov. 25, 2008.

(51) Int. Cl. G06Q 30/00; G06F 15/16

(52) U.S. Cl. 705/26; 709/217; 705/1.1

(57) ABSTRACT

A networked computing system capable of distributing commercial digital media content utilizing existing interpersonal resources of a social network service (SNS). The networked computing system includes a media content provider (MCP), multiple personal computing devices (PCDs), a SNS and a data communications network that facilitates data communications amongst the MCP, the PCDs, and the SNS. A registered user of the SNS at a first PCD is able to access media content emanating from a MCP based on a media content referral from a registered user of the same SNS at a second PCD. The SNS may operate as an agent for the MCP so that the MCP can use the SNS as a viral media content marketing utility.

### CROSS REFERENCE TO RELATED APPLICATIONS

The present application claims the benefit of U.S. Provisional Application No. 61/117,629, filed Nov. 25, 2008.

### FIELD OF THE INVENTION

The field of the present invention generally relates to systems and methods that can facilitate both independent and mass commercial media content distribution over media content supplier channels that can be integrated within existing or newly developed social network services (SNSes). The present invention further relates to media content distribution techniques that utilize viral marketing to allow distributors to effectively reach untapped consumer resources across popular SNSes.

### BACKGROUND OF THE INVENTION

Over the past decade, several prominent social network services (SNSes) have burst onto scene as major players in the modern Internet advertising marketplace. A few widely known SNSes include MySpace®, Facebook®, YouTube®, LinkedIn®, Twitter®, Flickr®, Bebo®, etc. The lure of these SNSes to commercial and non-profit advertising and marketing groups is the exponential growth of popular SNSes' clientele over relatively short periods of time. For example, Facebook® was launched in February of 2004 and as of 2008 it was estimated to already comprise over 300 million members worldwide. Viral marketing over web-based SNSes is projected to continue to have an increasing market share for advertising and marketing expenditures not only due to increasing quantities of SNS users, but also due to the fact that the average amount of time that SNS users spend “logged-on” at SNS websites is also increasing.

This increase in average SNS user activity is largely attributed to the fact that most modern consumers have broadband Internet access at home, work, school, and even on the go using a variety of state-of-the-art wireline and wireless data communications technologies (e.g., desktop and laptop computers, netbooks, cellular phones and PDAs, e-book devices, etc.). With increased network availability, users are continually using Internet resources that were once strictly accessible over wireline broadband networks. One popular example of a group of perpetual, “around-the-clock” SNS users can be seen with many clientele of the SNS Twitter®. Using Twitter®, SNS users can routinely “tweet” throughout the course of a day by transmitting simple text message or blog comments to their subscribers or “followers.” In this way, subscribers to a particular user's SNS account can be readily apprised of what their associate is up to throughout the course of any given day. With the advent of many popular SNSes like MySpace®, Facebook®, YouTube®, and Twitter®, many consumers today are already spending more time actively participating in SNS activities than they are engaging in many other work-related, social, and recreational activities.

Many SNSes facilitate the construction of online communities of friends, family members, co-workers, business partners, religious groups, political organizations, etc., who collectively share common interests and/or interpersonal relationships. SNS community members are able to interact through their respective SNSes using e-mail and blog commenting, along with a variety of other messaging services, including: instant messaging (IM), short message service (SMS), enhanced message service (EMS), and multimedia message service (MMS). Some SNSes, such as Facebook®, MySpace®, and YouTube® also allow users to share personal digital image and audio-visual content directly through the SNS interface (e.g., a SNS webpage). For example, an individual could post a digital image or a short home video to their Facebook® webspage's “wall” (a textual and media content blog space) or their MySpace® personal webpage for select linked friends to view, if they so choose. Similarly, many individuals can post a variety of video content to the publicly available YouTube® website, such that any member of the general public can view their uploaded video content.

Most “friend” or “connection” based SNSes (e.g., Facebook®, MySpace®, and LinkedIn®) require acquainted individuals to each confirm that they approve of being affiliated with a particular individual or community of users before they are authorized to mutually share information and access personal media content over a particular SNS. Additionally, most SNSes generally have privacy controls that allow its users to choose who can contact them over the SNS as well as who can access various elements of their SNS webpage content. Because SNS users selectively choose who they allow to view their personal profile information, media content, and commentary, there is generally an inherent level of trust, based on common interests and/or interpersonal relationships, amongst many affiliated or linked social network users. Due to the fact that a majority SNS relationships are built on trust and familiarity, connection based SNSes are ideal venues for referral-based marketing over the Internet.

Many SNSes and their affiliates (e.g., the Facebook® and MySpace® advertising affiliate AdParlor®) offer advertising services to community users based on user preferences and personal webpage content. Currently there are three major categories of SNS advertising:
1) Activity-based advertising that relies on the activities of SNS users and/or SNS communities to make advertising decisions. For example, with activity-based advertising individuals can sometimes see what commercial activities other individuals in their SNS community are up to. For example, a member might receive a notification indicating that their friend “Mary” just purchased the new Coldplay® CD from a certain online media content provider (MCP) at a sale price of only $7.99. Some of Mary's SNS friends or “followers” might also wish to make a similar purchase from the same MCP based on an advertisement informing them of their friend Mary's commercial activity. This method of advertising can be extremely effective, but is often very invasive, and it has raised many privacy issues. For example, Mary may not want all or any of her SNS connections viewing her online commercial activities for a variety of professional and personal reasons. At the very least Mary would likely wish to be able to elect which sub-groups of her SNS friends should be allowed to view her online commercial activities.
2) Directed advertising placed on a SNS user's webpage by a variety of different advertisers. This is a common web-based advertising technique where online advertisers often pay to place banner, button, skyscraper, and/or pop-up type advertisements on a webpage belonging to a particular SNS user based on demographic data and personal content obtained from the SNS user's webpage. In this way, advertising and marketing agents can directly target specific advertisements to particular SNS members or communities of a SNS. For example, if a SNS user's personal SNS webpage indicated that the user was in their late teens or early twenties and that they had multiple textual, image, and/or video references to sports content, the advertising and marketing agents for select athletic clothing and equipment suppliers, such as Nike®, Adidas®, and/or Reebok®, might wish to direct advertisements to this user along with the user's friends or affiliated communities that have similar interests.
3) Indirect advertising by creating SNS communities linked to affiliated websites offering commercial services. With this advertising technique, a company can lure SNS users into joining their hosted SNS community and then market (e.g., through contests or promotions) new or existing commercial products, or alternatively just market to increase brand and product line awareness.

Even with the availability of these modern SNS advertising and marketing techniques, there remains a need for effective, consumer-powered solutions for marketing and distributing commercial media content (e.g., movies, television programs, sports broadcasts, radio broadcasts, podcasts, music, video games, e-books, and/or software) amongst SNS users and their communities. It would be beneficial if these distribution solutions were facilitated by user referrals amongst communities of SNS users so that the commercial success or failure of a particular media content were based on the substantive merits of the media content's quality and consumer appeal. In this way, consumers could learn what other individuals (e.g., trusted friends having similar entertainment interests) felt about select media content, without being solely influenced by the views of biased media content critics and the mass advertising and marketing efforts of major media content distributors.

As one example of existing deficiencies associated with modern media content distribution services, many independent film makers today regularly produce high quality “indie” films that typically only generate a fraction of the revenue generated by sub-par films produced by their major film studio counterparts. A few examples of modern major film studios include: Warner Bros. Pictures®, Paramount Pictures®, Columbia Pictures®, Universal Studios®, 20th Century Fox®, and Walt Disney Pictures®/Touchstone Pictures®. The reason many independent media content producers struggle to compete with major media content producers in their respective fields is the fact that there are a limited number of media content distribution channels available to push media content and major media content producers have the capital resources to consume the lion's share of available, popular distribution channels. Some of these distribution channels include: large movie theatre chains, media content rental and retail sales stores (both physical and online stores), as well as proprietary digital MCPs over cable, fiber-optic, satellite, and cellular communications networks. Further still, independent MCPs generally lack the financial backing to compete with their mainstream counterparts in the fields of mass advertising, marketing, and production of physical media. Due to these advertising and distribution obstacles, independent MCPs (e.g., independent film makers) often rely on word-of-mouth, a form of referral marketing, in order to commercially distribute their media content.

Accordingly, it would be beneficial to have dynamic media content distribution services that could facilitate cost-effective distribution of commercial media content through viral marketing over multiple SNSes. It would further be desirable if the systems and methods facilitating these distribution services could be integrated within new or existing SNSes to allow for media content distribution channels to be implemented at the SNS user level in collaboration with various MCPs offering a diversity of commercially available media content. It would also be advantageous to both independent MCPs and major MCPs alike, if SNS users could selectively view and evaluate a particular MCP's respective media content surplus independently and then elect to promote favored media content to other SNS users by generating media content referrals. Additionally, it would be beneficial if these media content referrals (both direct referrals and indirect referrals) could facilitate easy access to referred media content through user generated or MCP generated media content distribution channels.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with existing media content distribution systems, the present invention discloses an improved networked computing system for distributing digital media content. The network computing system may include a media content provider (MCP), multiple personal computing devices (PCDs), a social network service (SNS) having multiple registered social network users, and a data communications network facilitating data communications amongst the MCP, the PCDs, and the SNS. In an embodiment, a registered user of the SNS at a first PCD is able to access media content emanating from the MCP based on a media content referral from a registered user of the SNS at a second PCD, utilizing the SNS as an intermediary.

In accordance with another aspect of the present invention, the SNS may operate as an agent for the MCP, such that the MCP can utilize the SNS as a viral marketing tool for various media content.

In accordance with a further aspect of the present invention, the media content emanating from the MCP may be commercial media content that a registered user must pay for in accordance with the terms of a service agreement in order to utilize.

In accordance with yet another aspect of the present invention, the media content emanating from the MCP may include movies, television programs, sports broadcasts, radio broadcasts, podcasts, music, video games, e-books, and/or software.

In accordance with still a further aspect of the present invention, the registered user at the second PCD may elect to push media content to the registered user at the first PCD as part of the media content referral.

In accordance with another aspect of the present invention a computer-readable medium is encoded with computer-executable instructions for distributing digital media content. When the computer-executable instructions are executed, at least the following processes are performed: registering a user at a first personal computing device (PCD) and a user at a second PCD with a SNS, transmitting a media content referral from the registered user at the second PCD to the registered user at the first PCD, utilizing the SNS, and accessing media content emanating from a media content provider (MCP) with the first PCD based on the received media content referral.

In accordance with yet a further aspect of the present invention, is a computer-implemented method for distributing digital media content, the method including at least the following processes: registering a user at a first personal computing device (PCD) and a user at a second PCD with a SNS, transmitting a media content referral from the registered user at the second PCD to the registered user at the first PCD, utilizing the SNS, and accessing media content emanating from a media content provider (MCP) with the first PCD based on the received media content referral.

In accordance with another aspect of the present invention, is a computer-implemented method for distributing digital media content, the method including the following processes: associating a media content provider (MCP) with a SNS having multiple registered users, designating media content access rules for media content transmitted to registered users of the SNS, and distributing media content emanating from the MCP to a first registered user of the SNS based on a media content referral from a second registered user of the SNS.

In accordance with yet another aspect of the present invention, the media content emanating from the MCP is commercial media content and the media content access rules may include payment rules, referral rules, DRM rules, and/or access restriction rules.

In accordance with a further aspect of the present invention, the distributed media content may be accessed by the first registered user of the SNS in accordance with media content payment rules that require social network users to make payment directly or indirectly to the MCP prior to utilizing distributed media content.

In accordance with a further aspect of the present invention, the MCP and the SNS may collaboratively establish access rules pertaining to particular subsets of registered social network users.

### BRIEF DESCRIPTION OF THE DRAWINGS

Preferred and alternative examples of the present invention are described in detail below with reference to the following Figure drawings:

FIG. 1 illustrates a perspective view of a media content distribution system in accordance with an embodiment of the present invention;

FIG. 2 illustrates a perspective view of a relational social network service (SNS) computing architecture in accordance with an embodiment of the present invention;

FIG. 3 illustrates a block diagram view of a personal computing device (PCD) in accordance with an embodiment of the present invention;

FIG. 4 illustrates a block diagram view of a media content provider (MCP) in accordance with an embodiment of the present invention;

FIG. 5 illustrates a flow diagram depicting registration and media content referral processes associated with an embodiment of the present invention;

FIG. 6 illustrates a system flow diagram depicting media content request, transfer, and referral processes associated with an embodiment of the present invention;

FIG. 7 illustrates a system flow diagram depicting acquired media content access and utilization processes associated with an embodiment of the present invention;

FIG. 8 illustrates a system flow diagram depicting media content acquisition, access, and utilization processes associated with an embodiment of the present invention;

FIG. 9 illustrates a system flow diagram depicting MCP pushed media content delivery, access, and utilization processes associated with an embodiment of the present invention;

FIG. 10 illustrates a system flow diagram depicting user pushed media content delivery, access, and utilization processes associated with an embodiment of the present invention;

FIG. 11 illustrates a flow diagram depicting MCP and SNS affiliation and access rules establishment processes associated with an embodiment of the present invention;

FIG. 12 illustrates an interactive Media Content Transfer Manager (MCTM) application interface displayed as a browser-based add-on component at a MCP website in accordance with an embodiment of the present invention; and

FIG. 13 illustrates an interactive account setup interface displayed as at a MCP website in accordance with an embodiment of the present invention.

### DETAILED DESCRIPTION

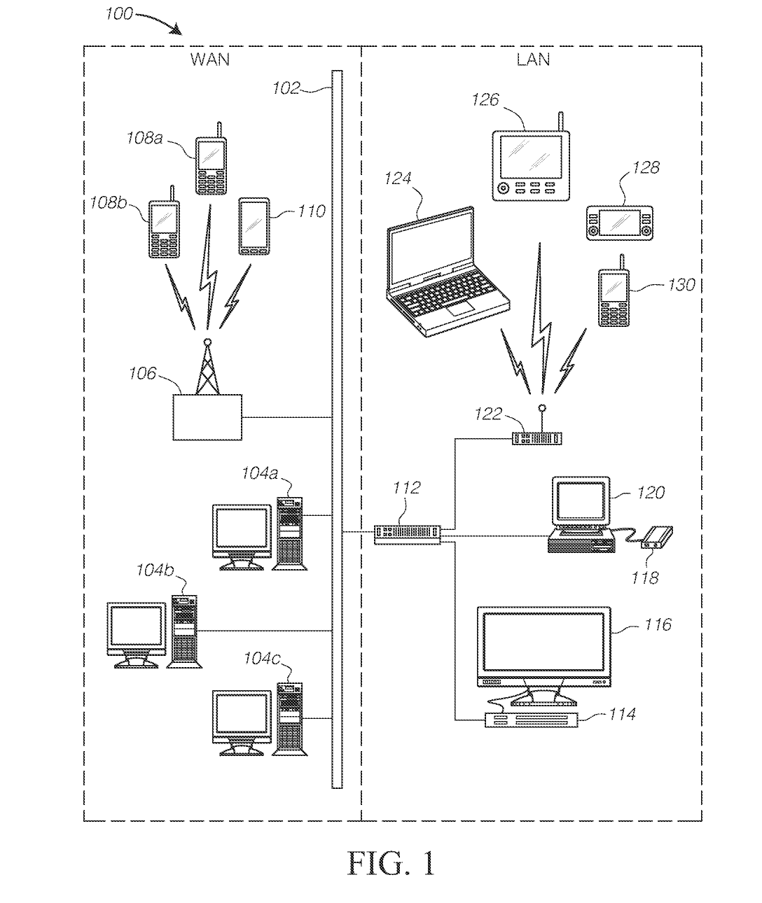

In accordance with an exemplary embodiment of the present invention, FIG. 1 illustrates a networked computing system 100 including various wireline and wireless computing devices that may be utilized to implement any of the media content acquisition, referral, and distribution processes associated with various embodiments of the present invention. The networked computing system 100 may include, but is not limited to, a group of remote server devices 104a-c, any one of which may be associated with various media content providers (MCPs) that can support digital media content distribution services (including media content referral services) to various networked clientele devices or with various social network services (SNSes) that can provide for viral media content marketing and distribution services affiliated with particular MCPs; a data communications network 102 (including both Wide Area Network (WAN) and Local Area Network (LAN) portions); a variety of remote wireless communications devices, including cellular phones 108a-b and Personal Desktop Assistant (PDA) devices 110, that may be connected to the data communications network 102 utilizing one or more wireless basestation 106 or any other common wireless or wireline network communications technology; one or more network gateway or switch devices 112 that can facilitate data communications processes within the LAN and between the LAN and the WAN of the data communications network 102; a television device 116 (e.g., a high definition LCD or Plasma television) that is connected to a multi-media device 114 (e.g., a set-top box, digital video recorder (DVR), Blu-Ray™ player, and/or a digital video disk (DVD) player/recorder device); a desktop computer 120 optionally connected to an external hard-drive device 118; a wireless router 122 that may communicate with various wireless LAN devices using any common local wireless communications technology, such as Wi-Fi™ or unshielded twisted pair cable; a wireless laptop computer 124; an electronic book device 126, a wireless handheld gaming unit 128; and a cellular phone device 130.

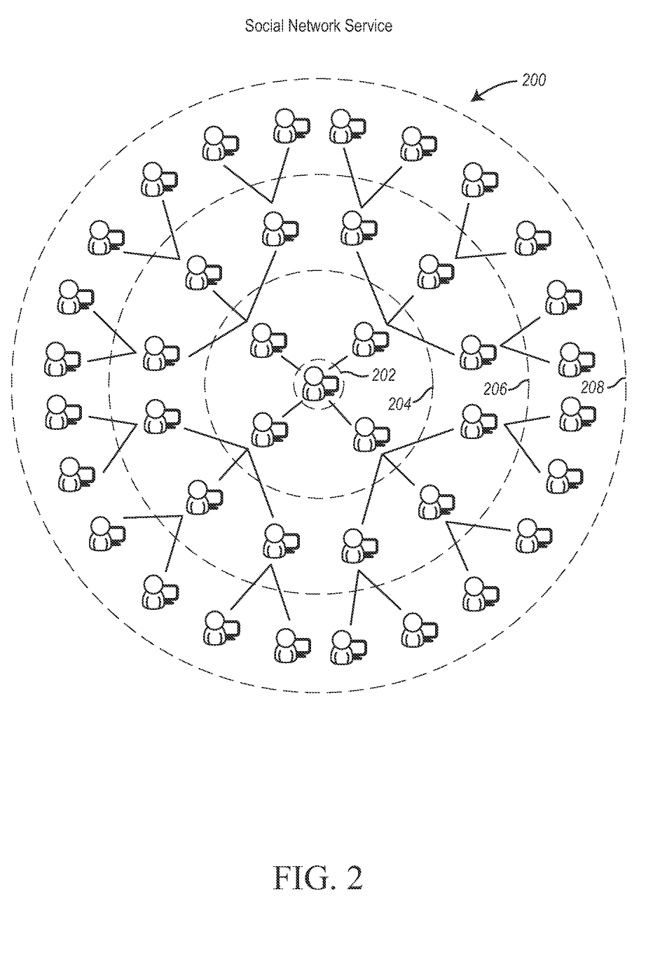

FIG. 2 represents a relational computing architecture associated with a SNS 200 in accordance with an embodiment of the present invention. As would be understood by those skilled in the art, most modern relationship-based SNSes (e.g., Facebook®, MySpace®, LinkedIn®, and Twitter®) facilitate the construction of online communities of friends, family members, co-workers, business associates, etc., who collectively share common interests and/or interpersonal relationships. SNS users can interact with one another through their respective SNSes using e-mail and blog commenting, along with a variety of other messaging services, including: instant messaging (IM), short message service (SMS), enhanced message service (EMS), and multimedia message service (MMS). The SNS 200 depicted in FIG. 2 may require acquainted members to individually confirm that they approve of being affiliated with other SNS members or communities before they are authorized to interact and share information (including digital media content). Additionally, the SNS 200 may have privacy settings and controls that allow its members to choose who can contact them over the SNS 200 as well as who can access various elements of their SNS webpage and associated media content.

The SNS 200 computing architecture depicts imaginary, concentric rings 202, 204, 206, and 208 that illustratively depict relational tiers of socially linked individuals (represented by figures of people standing next to their respective personal computing devices (PCDs)) in a social network. In FIG. 2, it should be understood that all socially linked individuals (individuals joined by solid lines) can communicate with one another over some type of wireline or wireless communications network (e.g., data communications network 102 of FIG. 1, including both WAN and LAN portions). Further, each user depicted in FIG. 2 is assumed to have access to one or more PCD (e.g., any of the PCDs 108a-b, 110, 114, 116, 120, 124, 126, 128, and 130 depicted in FIG. 1), which they can use to communicate over a common SNS (e.g., a SNS provided by any of the remote server devices 104a-c depicted in FIG. 1).

The area encompassed by concentric ring 202 represents a first social network tier including a single SNS member, which will be hypothetically named “Bob”, for illustrative purposes. In an embodiment, Bob may elect to sign up for a SNS 200 to which many of his friends already belong. From Bob's perspective, he is at the center of his social network. Over a period of time, Bob adds a group of close friends to his social network. These friends are depicted as residing within a second social network tier between concentric rings 202 and 204. Bob and his friends in the second social network tier are directly linked and in accordance with mutually determined content privacy privileges, Bob and his friends may be able to share information and media content residing on their respective SNS webpages. Bob's friends in the second social network tier between concentric rings 202 and 204 are each able to have other friends that may only be indirectly linked with Bob. These additional friends are depicted as residing within a third social network tier between concentric rings 204 and 206 and can be viewed as being Bob's friends' friends. Similarly, this relational outgrowth of directly linked or indirectly linked friends can continue on indefinitely. For example, Bobs friends' friends residing within the third social network tier between concentric rings 204 and 206 can further have their own group of friends residing within a fourth social network tier between concentric rings 206 and 208. These individuals can be viewed as being Bob's friends' friends' friends . . . and so on.

Within this SNS 200 architecture Bob could transfer a copy of a particular digital media content to his friends, who could then transfer copies of the copy of digital media content to their friends, who could then in turn transfer copies of individual copies of the copy of digital media content to their friends, until there was a substantial viral distribution of multiple levels of copies of the same digital media content, emanating from Bob. This basic example illustrates how easily and efficiently digital media content can be virally distributed to a large number of individuals within a relationship based SNS 200. As will be discussed further herein, various embodiments of the present invention capitalize on this relational networking effect in order to efficiently distribute media content referrals, recommending various media content (e.g., movies, television programs, sports broadcasts, radio broadcasts, podcasts, music, video games, e-books, and software), amongst linked SNS users.

Consistent with various embodiments of the present invention, a media content referral or simply a “referral” may include, but is not limited to, information relating to a referral originator, a referral recipient, a particular media content or a link to a particular media content (optionally residing at a MCP, a SNS, or a PCD of a SNS user), media content access rules (e.g., payment rules, referral transfer rules, DRM rules, and access restriction rules), as well as a media content rating or review information. In an embodiment, referrals can be transmitted between SNS users directly or indirectly utilizing a MCP and/or a SNS as an intermediary. Whether a referral comprises a media content file, a media content link, or whether a referral is sent directly or indirectly between SNS users, the goal of the referral should be the same: to inform SNS referral recipients about a sending user's opinion of one or more user experienced media content (e.g., a media content viewed or listened to by a sending user). In various embodiments of the invention, referrals are intended to only include positive media content recommendations. In other embodiments, referrals may include both positive and/or negative media content reviews. Further, referrals may be purely informative and may or may not include any media content or links to media content. In certain situations, users may wish to notify friends not to waste their money purchasing a poorly created media content (e.g., a digital movie or music file available at a MCP)

In accordance with various embodiments of the present invention, the media content distribution systems and methods of the present invention may include at least the following components: one or more media content distribution channels, one or more MCP/SNS user accounts, media content management services, and billing services.

Media content distribution channels are at the core of what makes viral distribution of media content over SNSes function. In an embodiment, a “channel” may be defined as a customizable collection of media content and/or links to media content (e.g., hyperlinks referencing the location of media content stored at a MCP), presented in a web-based format (e.g., a web-based format based on HTML or Java script), which a user generates in order to share with other linked SNS users. For example, a first SNS user may create a channel and then publish a variety of commercial and non-commercial media content to that channel in order to share the published media content with SNS friends or connections. In accordance with an embodiment of the invention, a first user's channel content may reside at a MCP, a SNS, or an externally linked computing device, such as a user's PCD.

A second SNS user may receive a referral or an invitation to visit the first user's channel. Upon “tuning-in” or accessing the channel, the second user may be able to preview, view, and/or download any media content at or referenced by the channel in accordance with user or MCP/SNS defined access rules (e.g., payment rules, referral rules, DRM rules, and/or access restriction rules). In various embodiments, SNS users can create media content channels and then elect to customize their channels with media content of their own choosing (e.g., movies, television programs, sports broadcasts, radio broadcasts, podcasts, music, video games, e-books, and software). This selected media content may be media content already existing on a user's PCD (e.g., any of the PCDs 108a-b, 110, 114, 116, 120, 124, 126, 128, and 130 of FIG. 1) or media content residing on and/or emanating from a MCP (e.g., a MCP represented by any of remote server devices 104a-c of FIG. 1). As many users reference other SNS user's and MCP's channels through referrals, media content may be virally distributed and consumed by vast numbers of SNS users in short periods of time. The simplicity of this model can provide for a natural growth of distribution for popular, quality media content within new or existing SNSes.

In an embodiment, media content distribution channels may be customized by: settings rules indicating which SNS users can view, subscribe, or reference a channel (e.g., from another media content distribution channel); publishing new media content to a channel; referencing media content that belongs to other channels; sending referrals or invites to select SNS users to attempt to get them to subscribe to a user's channel; and setting advertisement preferences, optionally including a channel that may be marketed within a SNS. In accordance with an embodiment, every media content distribution channel may be associated with a particular SNS user or a MCP account. Generally there may be at least two different types of accounts affiliated with various media content channels.

The first type of account is a commercial account (e.g., an account belonging to a MCP) that can include at least the following components: one or more media content distribution channels to be established with a particular SNS; a variety of media content to be published to a channel for subscribers to purchase from the commercial MCP service; sales term agreements to be established for payment designation and scheduling, preceding or following media content downloads; access rules (e.g., payment rules, referral rules, DRM rules, and/or access restriction rules) to be authorized for select media content; and additional content to be added to a channel in accordance with the access rules of existing media content.

The second type of account is a non-commercial account that can include at least the following components: optional channel establishment with a particular SNS; published non-commercial media content (e.g. free digital photos, videos, music, etc.) that others SNS users can download at no charge; additional content to be added to a channel in accordance with the access rules (e.g., payment rules, referral rules, DRM rules, and access restriction rules) of existing media content; friends group creation or modification to allow public or private subscription to a particular channel; access and subscription preferences for other channels to set notification and download preferences for those channels; channel referral preferences, including referrals that allow for media content to be proactively pushed to other subscribers if they have agreed to allow this type of media content transfer; and favorite subscribed channels listings indicating a user's or a group of users' channel preferences.

In an embodiment, a SNS content management system may handle all the content ownership details, rules, and media content delivery logistics for SNS subscribers. Generally all media content is associated with at least one SNS integrated channel. In an embodiment, media content may only be published or owned by one channel, although it can be added to or referenced by many other SNS channels. In an embodiment, the SNS content management system manages: content publication and ownership; links between actual media content; references to media content on various user channels; media content billing preferences; media content advertisement preferences; media content DRM keys; order processing and delivery via media content transfer algorithms; and search utilities that may allow users to search for commonly referred media content.

As would be understood by those skilled in the art, a DRM system is a system that protects copyrighted media content data that is circulated over the Internet or any other digital medium, by enabling secure distribution of proprietary media content data. Typically, a DRM system protects copyrighted media content data by either encrypting or digitally watermarking it in such a way that only an intended recipient can intercept, decrypt (using DRM keys), and utilize the media content data. In this way, DRM technology can ensure that copyrighted media content will not be freely distributed to unauthorized users.

In an embodiment, there are a variety of billing scenarios that can be managed by a MCP. Each item of commercial media content may be associated with a set of billing preferences set by the media content owner (e.g. a media content pricing schedule). Some billing scenarios may include: establishment of user payment methods, such as credit cards, pre-paid credit, gift cards, and debit accounts that a SNS can utilize when purchasing media content; in accordance with one scenario a first user refers a media content to a second user, then the second user receives a referral for the media content, chooses to acquire the referred media content, pays a fee set by the media content owner, and receives the referred media content; in accordance with another scenario, a first user refers a media content a second user and accepts payment responsibility, such that when the second user receives referred media content the first user's billing account is charged; in accordance with a further scenario, a first user is subscribed to a channel and requests all new media content posted to the channel to be automatically delivered to their PCD, such that the first user is billed when they actually consume (e.g., unlock, view, and/or listen to) delivered media content; and in accordance with another scenario, a user pays a subscription fee for unlimited access to a channel which allows for unrestricted downloads according to that channel's predetermined pricing schedule.

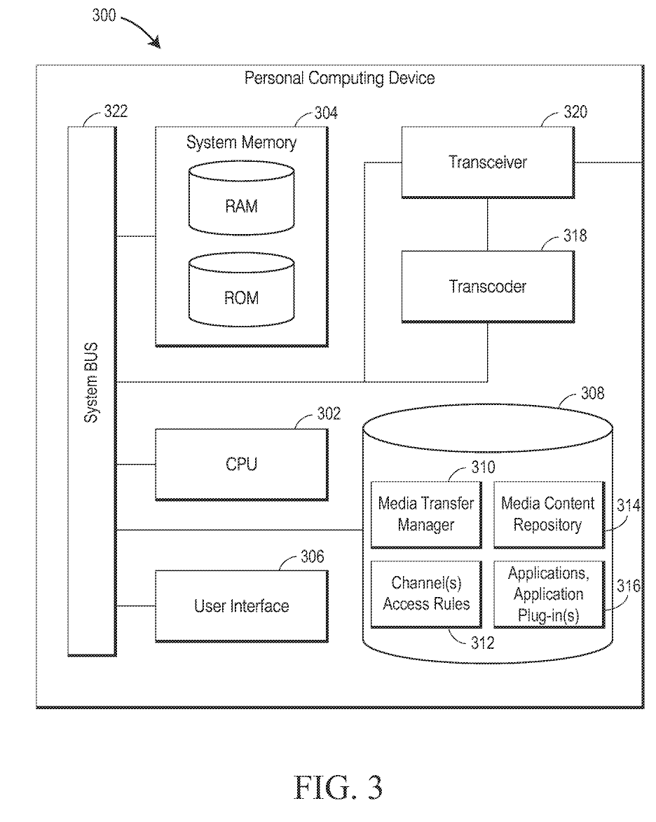

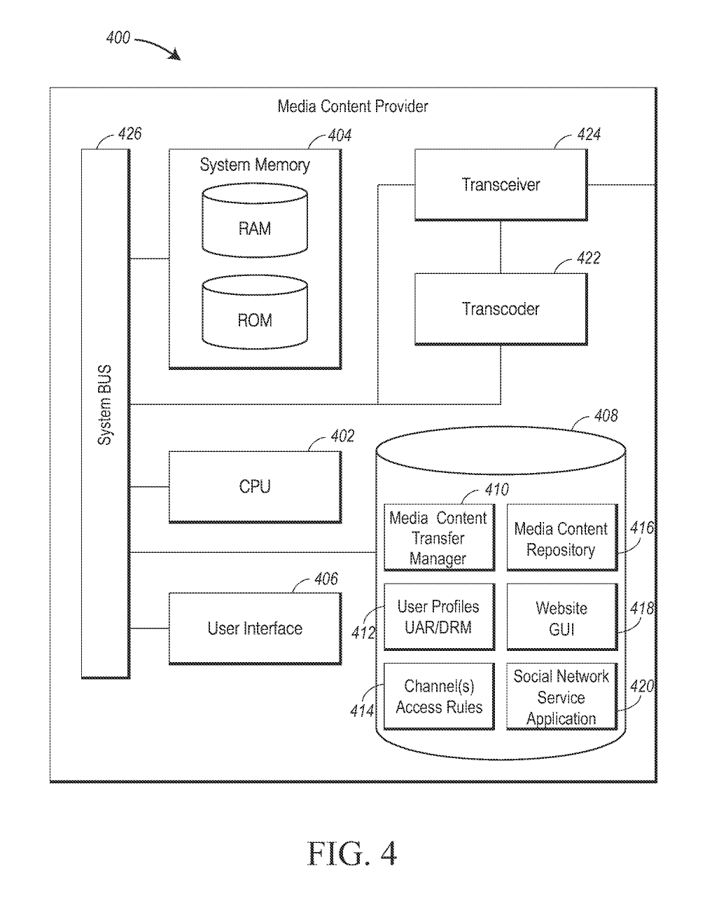

As will be discussed further herein, the media transfer management functionality associated with the Media Transfer Manager (MTM) application (e.g., 310 of FIG. 3) an the Media Content Transfer Manager (MCTM) application (410 of FIG. 4) of the present invention may individually or cooperatively facilitate media content download or upload processes to particular SNS media content channels (e.g., channels 312 or 414). These processes can allow media content to be downloaded from a particular source channel to a particular receiving PCD, or to be uploaded from a sending device (e.g., a MCP or a user's PCD) to a particular receiving channel. Practical applications employing these differing embodiments will be made apparent herein.

In an embodiment, the remote server devices 104a-c, the wireless basestation 106, the remote wireless communications devices (108a-b or 110), and any of the LAN connected computing devices (114, 116, 118, 120, 124, 126, 128, or 130) may be configured to run any known operating system, including but not limited to, Microsoft® Windows™, Mac OS™, Linux™, Unix™, or any common mobile operating system, including Symbian™, Palm™, Windows® Mobile™, Mobile Linux™, MXI™, etc. In an embodiment, the remote server devices 104a-c and the wireless basestation 106 may employ any number of common server, desktop, laptop, and personal computing devices. In an embodiment, the remote wireless communications devices (108a-b or 110) and the LAN connected computing devices (114, 116, 118, 120, 124, 126, 128, or 130) may include any combination of common mobile computing devices (e.g., laptop computers, netbook computers, cellular phones, PDAs, gaming units, e-book devices, personal music player devices, etc.), having wireless communications capabilities employing any common wireless data commutations technology, including, but not limited to: Bluetooth™, Wi-Fi™, Wi-Max™, GSM™, UMTS™, etc.

In an embodiment, either of the LAN or the WAN portions of the data communications network 102 of FIG. 1 may employ, but are not limited to, any of the following common communications technologies: optical fiber, coaxial cable, twisted pair cable, Ethernet cable, and powerline cable, along with any wireless communication technology known in the art. In an embodiment, any of the remote server devices 104a-c, the wireless basestation 106, the LAN connected computing devices (114, 116, 118, 120, 124, 126, 128, or 130), or the remote wireless communications devices (108a-b or 110) may include any standard computing software and hardware necessary for processing, storing, and communicating data amongst each other within the networked computing system 100. The computing hardware realized in any of the data communications network 102 computing devices (104a-c, 106, 108a-b, 110, 112, 114, 116, 118, 120, 122, 124, 126, 128, or 130) may include, but is not limited to, one or more processors, volatile and non-volatile memories, user interfaces, transcoders, and wireline and/or wireless communications transceivers, etc.

In an embodiment, any of the LAN-connected computing devices and the remote wireless communications devices (104a-c, 106, 108a-b, 110, 112, 114, 116, 118, 120, 122, 124, 126, 128, or 130), may be configured to include one or more computer-readable media (e.g., any common volatile or non-volatile memory type) encoded with a set of computer readable instructions, which when executed, performs a portion of one or more of the media content acquisition, referral, and distribution processes of the present invention.

FIG. 3 shows a block diagram view of a PCD 300 that may be representative of any of the LAN connected PCDs (e.g., 114, 116, 118, 120, 124, 126, 128 or 130) or the remote wireless communications devices (108a-b or 110) in FIG. 1. The PCD 300 may include, but is not limited to, one or more processor devices including a central processing unit (CPU) 302. In an embodiment, the CPU 302 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 302 is responsible for executing all computer programs stored on the PCD's 300 volatile (RAM) and nonvolatile (ROM) system memories, 304 and 308. The PCD 300 may also include, but is not limited to, a user interface 306 that allows a user to interact with the PCD' s software and hardware resources; a content database 308 that includes a media transfer manager (MTM) application 310, a set of media content channels and affiliated media content access rules 312 (e.g., payment rules, referral rules, DRM rules, and/or access restriction rules), a media content repository 314, as well as various software applications and application plug-ins 316; a transcoder 318 for formatting media content; a transceiver 320 for transmitting and receiving media content over the data communication network 102; and a system bus 322 that facilitates data communications amongst all the hardware resources of the PCD 300.

In an embodiment, the MTM application 310 may include both media content download and upload functionality that facilitates direct or indirect media content transfers amongst SNS user devices (104a-c, 106, 108a-b, 110, 112, 114, 116, 118, 120, 122, 124, 126, 128, or 130), MCPs (e.g., any of remote server devices 104a-c), and SNS hosted media content channels. In an embodiment, the media content repository 314 may include media content relating to the following media types: movies, television programs, sports broadcasts, radio broadcasts, podcasts, music, video games, e-books, and software. Generally, existing media content in the repository 314 may be optionally reformatted (e.g., with the Transcoder 318) before being uploaded to various channels or transmitted to various end receiving devices. In an embodiment, the applications and application plug-ins 316 stored in the database 308 (e.g., web-browsers, SNS client applications, browser plug-ins, etc.) may facilitate a user of the PCD 300 interacting with various MCPs and SNSes over the data communications network 102 of FIG. 1. In an alternate embodiment, the PCD 300 may be connected to any external memory device (e.g., external hard drive 118 of FIG. 1), which may be capable of storing any of the utilities and repositories (310, 312, 314, and 316) of the content database 308. In an embodiment, the PCD 300 may be capable of loading and running any application or utility directly from an external memory 118.

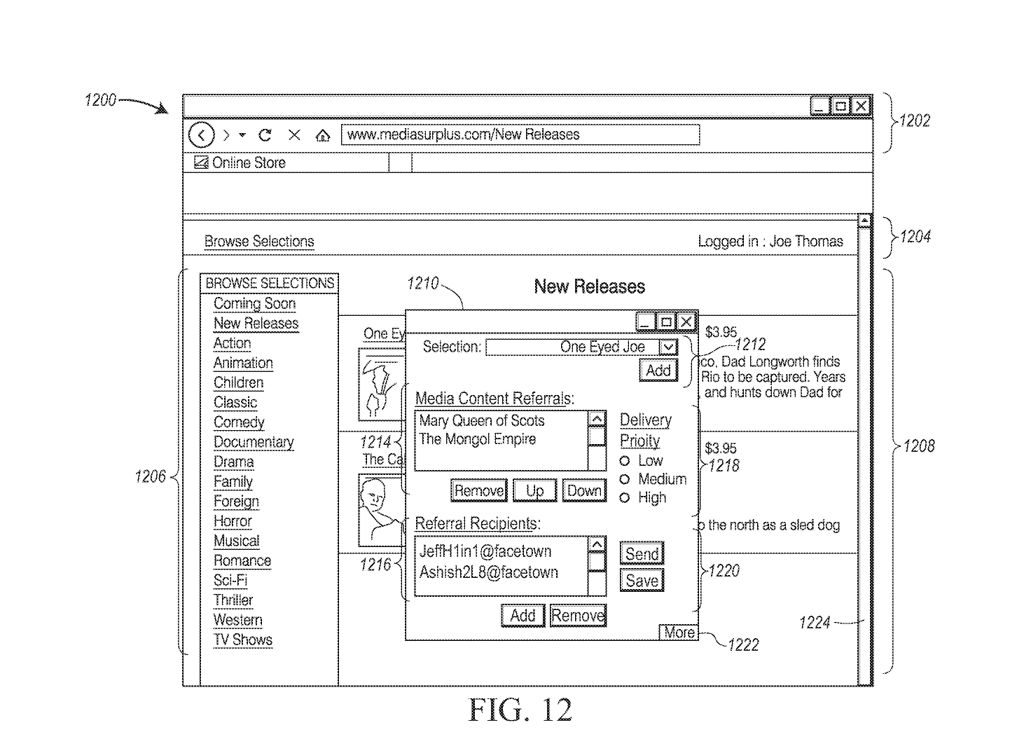

FIG. 4 shows a block diagram view of a Media Content Provider (MCP) 400 that may be representative of any of the remote server devices 104a-c in FIG. 1. The MCP 400 may include, but is not limited to, one or more processor devices including a central processing unit (CPU) 402. The CPU 402 is generally responsible for executing all computer programs stored on the MCP's 400 volatile (RAM) and nonvolatile (ROM) system memory, 404 and 408. The MCP 400 may also include, but is not limited to, an optional user interface 406 that allows a user/administrator to interact with the MCP's software and hardware resources; a system database 408 that includes a media content transfer manager application (MCTM) 410, a User Profile, User Access Rights (UAR), and Digital Rights Management (DRM) information repository 412, a set of media content channels and affiliated media content access rules 414 (e.g., payment rules, referral rules, DRM rules, and/or access restriction rules), a media content repository 416, a hosted website (See e.g., the MCP website depicted in FIG. 12) including various graphical user interface (GUI) components 418 (e.g., static HTML and dynamic components, such as Java based applications) that may facilitate a user making media content selections for purchase, download, and referral; and an optional SNS application 420 that facilitates media content referral and transfer processes between an affiliated SNS (and its clientele) and the MCP 400; a transcoder 422 for formatting deliverable media content; a network transceiver 424 that allows the MCP 400 to communicate across the LAN and WAN portions of the data communications network 102 of FIG. 1; and a system bus 426 that facilitates data communications amongst all the hardware resources of the MCP 400.

In an embodiment, the MCP's 400 MCTM application 410 may include media content transfer functionality that facilitates direct or indirect media content transfers amongst SNS user devices (104a-c, 106, 108a-b, 110, 112, 114, 116, 118, 120, 122, 124, 126, 128, or 130), and SNS hosted media content channels. In an embodiment, the media content repository 416 may include media content relating to the following media content types: movies, television programs, sports broadcasts, radio broadcasts, podcasts, music, video games, e-books, and software. Generally, media content in the repository 416 may be optionally reformatted (e.g., with the Transcoder 422) before being transferred to various channels or end receiving devices.

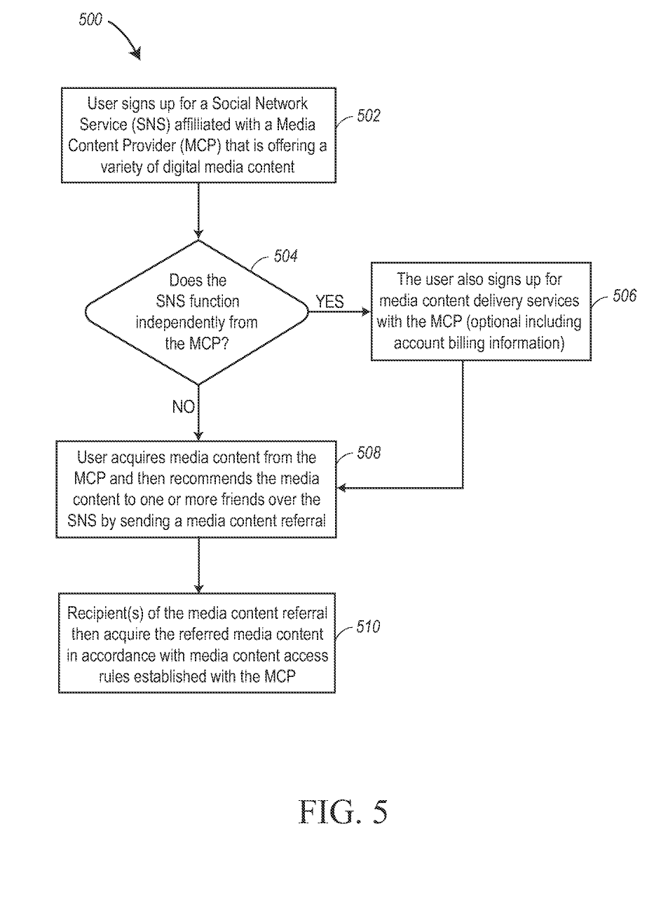

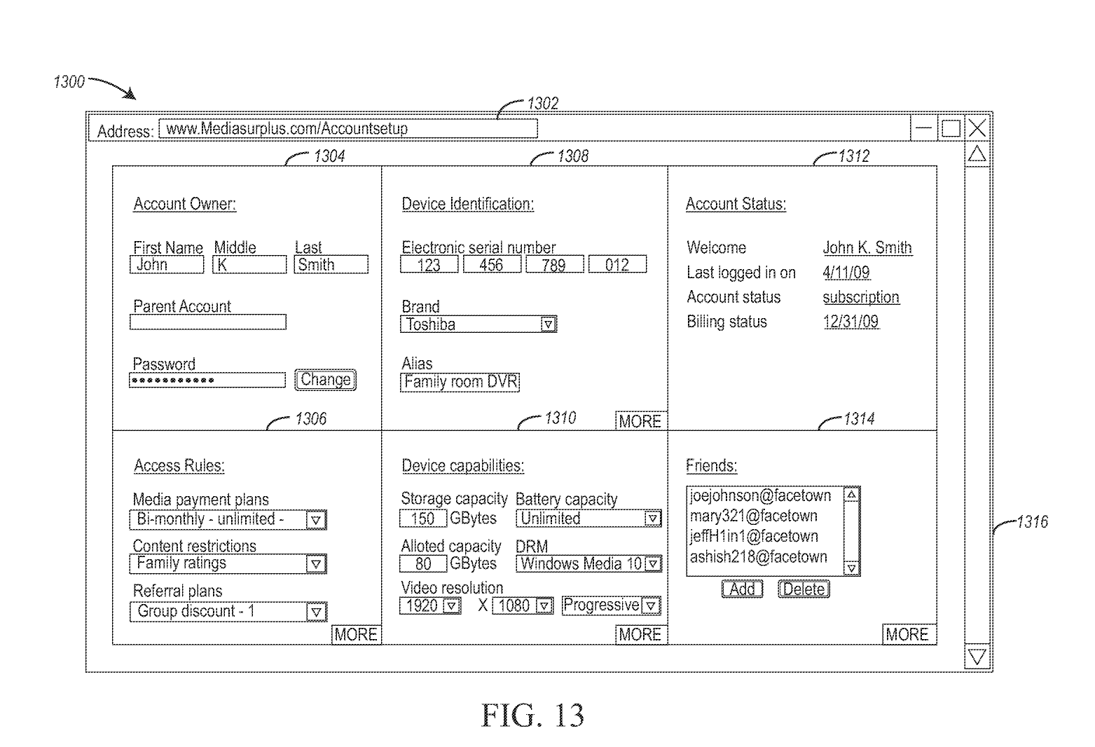

FIG. 5 illustrates a flow diagram 500 depicting media content registration and referral processes associated with an embodiment of the present invention. It should be understood that this process 500 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., any of remote server devices 104a-c) of FIG. 1. At block 502, a user of a PCD (e.g., any of 108a-b, 110, 114, 116, 118, 120, 124, 126, 128, or 130) signs up for a SNS affiliated with a MCP 400 that is offering a variety of commercially available digital media content (e.g., movies, television programs, sports broadcasts, radio broadcasts, podcasts, music, video games, e-books, and software). Next at decision block 504 it is determined if the SNS functions independently from the MCP 400. If the SNS functions independently, the process proceeds to block 506, where the user also signs up for media content delivery services with the MCP 400 (See e.g., the SNS/MCP user registration webpage of FIG. 13). The process then proceeds to block 508. However, if the SNS does not function independently from the MCP 400, the process proceeds to block 508, where a user acquires one or more media content from the MCP 400 and then optionally recommends the media content to one or more friends or connections over the SNS by sending one or more media content referrals. Next, the process proceeds to block 510, where the recipient(s) of the media content referral then acquire the referred media content in accordance with media content access rules (e.g., payment rules, referral rules, DRM rules, and/or access restriction rules) established with the MCP 400.

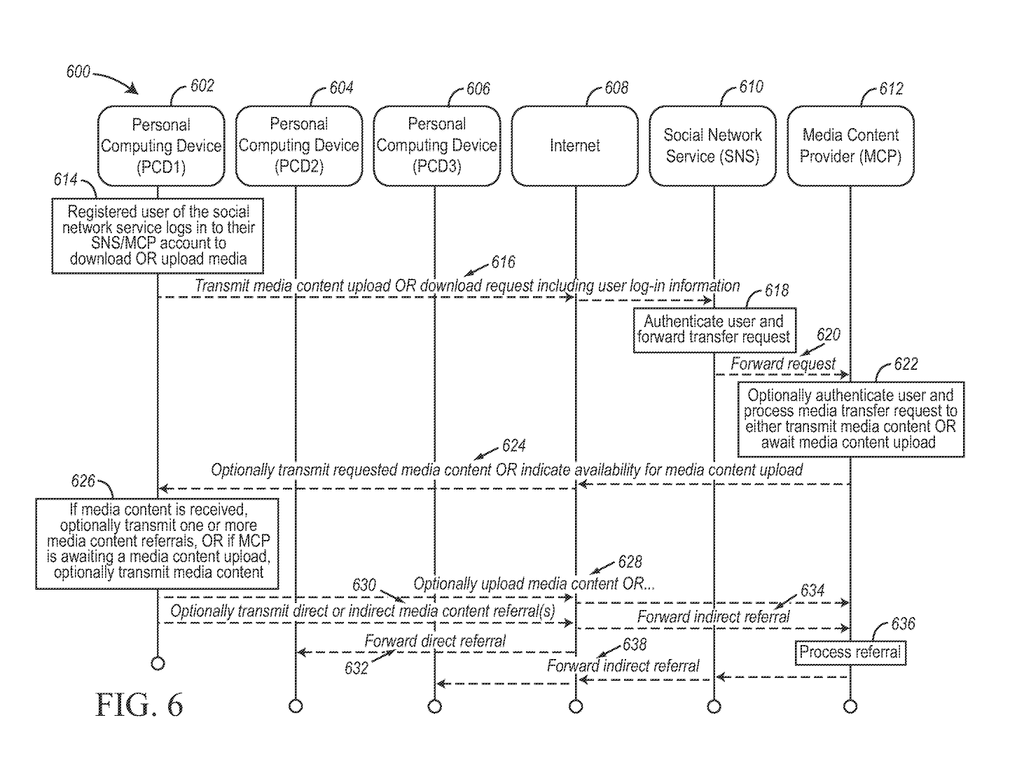

FIG. 6 illustrates a system flow diagram 600 depicting media content request, transfer, and referral processes associated with an embodiment of the present invention. It should be understood that these processes 600 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., represented by any of remote server devices 104a-c) of FIG. 1. In an embodiment, the system flow diagram 600 depicts data communications interactions amongst at least the following devices: a first personal computing device (PCD1) 602; a second personal computing device (PCD2) 604, a third personal computing device (PCD3) 606; the Internet 608 (e.g., the data communications network 102 of FIG. 1); a social network service (SNS) 610 (e.g., represented by any of remote server computing devices 104a-c); and a media content provider (MCP) 612 (e.g., represented by any of remote server computing devices 104a-c).

At block 614, a registered user of the SNS 610 logs in to their SNS/MCP account to initiate a download or an upload of one or more media content (e.g., movies, television programs, sports broadcasts, radio broadcasts, podcasts, music, video games, e-books, and software). Then the user transmits a corresponding media content upload or download request, including log in information (e.g., user name and password account information pertaining to a SNS and/or a MCP) 616. Next at block 618, the SNS 610 authenticates (e.g., by verifying user log in information) the user and forwards the transfer request 620 to the MCP 612. Then at block 622, MCP 612 also optionally authenticates the user (e.g., by verifying user log in information) and processes the media transfer request to either transmit media content or await media content upload. Next, the MCP 612 optionally transmits the requested media content or indicates availability for a media content upload. Subsequently at block 626, if media content is received by PCD1 602, a user at PCD1 602 may optionally elect to transmit one or more media content referrals, or if the MCP 612 is awaiting a media content upload, a user at PCD1 602 may optionally upload media content to the MCP 612. Then in a first optional process, a user at PCD1 602 may optionally upload media content 628 to the MCP 612. In a second optional process, a user at PCD1 602 may directly or indirectly transmit one or more media content referrals 630. In the direct referral process 632, PCD1 602 may directly transmit a media content referral to PCD2 over the Internet 608 using any common email, SNS, or messaging service (e.g., via IM, SMS, EMS, or MMS). In the indirect referral process 634, a user at PCD1 602 may transmit a media content referral to the MCP 612 that then processes the referral at block 636 and forwards the referral 638 through the SNS 610 to PCD3 606 over the Internet 608 using any common email, SNS, or messaging service (e.g., via IM, SMS, EMS, or MMS).

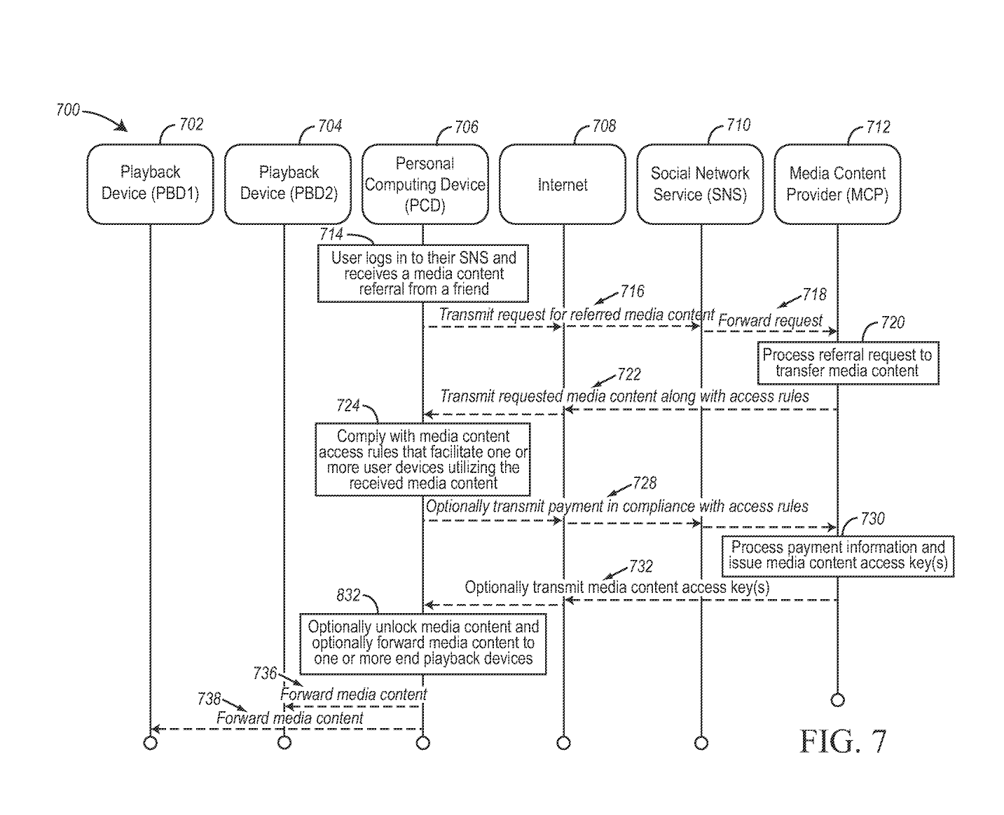

FIG. 7 illustrates a system flow diagram 700 depicting acquired media content access and utilization processes associated with an embodiment of the present invention. It should be understood that these processes 700 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., represented by any of remote server devices 104a-c) of FIG. 1. In an embodiment, the system flow diagram 700 depicts data communications interactions amongst at least the following devices: a first playback device (PBD1) 702; a second playback device (PBD2) 704, a personal computing device (PCD) 706; the Internet 708 (e.g., represented by the data communications network 102 of FIG. 1); a social network service (SNS) 710 (e.g., represented by any of remote server computing devices 104a-c); and a media content provider (MCP) 712 (e.g., represented by any of remote server computing devices 104a-c).

At block 714, a user logs in to their SNS and receives a media content referral from a friend. Then the user transmits a request for the referred media content 716, 718 to the MCP 712 through the SNS 710 over the Internet 708. Next, at block 720, the MCP 720 processes the referral request to transfer media content. Then the MCP 712 transmits the requested media content along with media content access rules 722 to the PCD 706 over the Internet 708. Then at block 724, the user of PCD 706 complies with the media content access rules (e.g., payment rules, referral rules, DRM rules, and/or access restriction rules) that facilitate one or more user devices utilizing the received media content. Then the user of PCD 706 optionally transmits payment in compliance with the access rules 728 over the Internet 708 to the MCP 712 via the SNS 710. Next, the MCP 712 processes the received payment information (e.g., credit card payment information or giftcard information) and issues 730 and optionally transmits 732 one or more media content access keys (e.g., DRM keys) that facilitate utilization of the previously received media content. Then at block 734, the user of the PCD 706 optionally unlocks the media content with the received access keys and then optionally proceeds to forward media content to one or more 736, 738 end playback devices (e.g., PBD1 702 and PBD2 704).

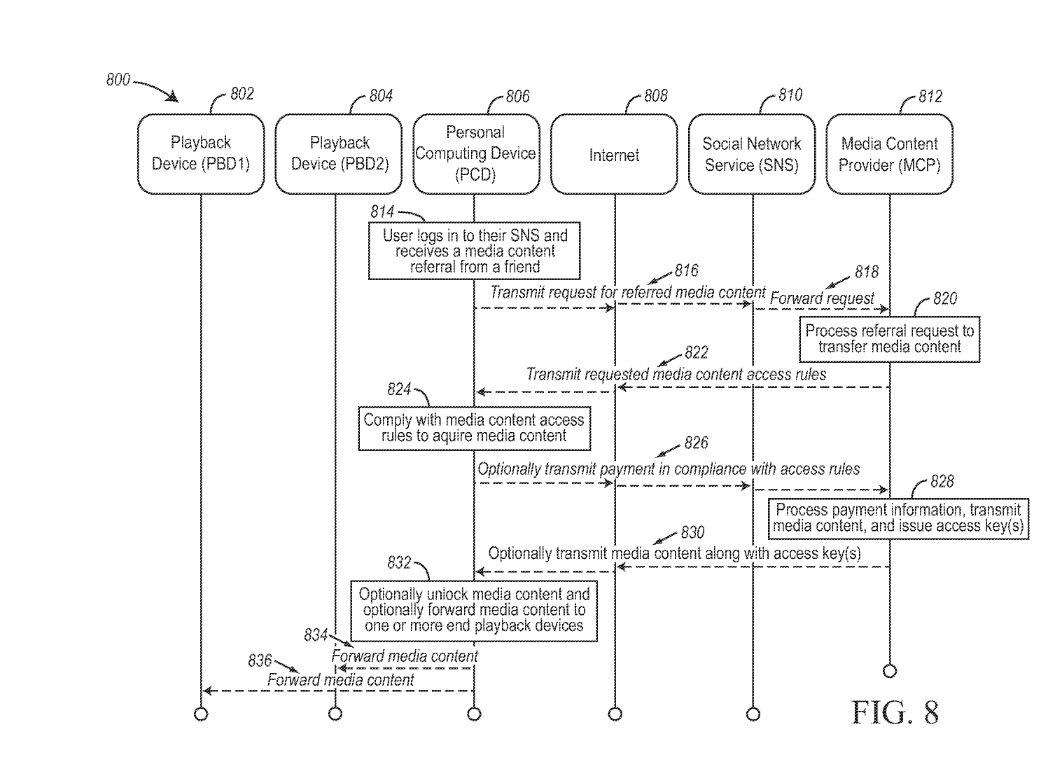

FIG. 8 illustrates a system flow diagram 800 depicting media content acquisition, access, and utilization processes associated with an embodiment of the present invention. It should be understood that these processes 800 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., represented by any of remote server devices 104a-c) of FIG. 1. In an embodiment, the system flow diagram 800 depicts data communications interactions amongst at least the following devices: a first playback device (PBD1) 802; a second playback device (PBD2) 804, a personal computing device (PCD) 806; the Internet 808 (e.g., represented by the data communications network 102 of FIG. 1); a social network service (SNS) 810 (e.g., represented by any of remote server computing devices 104a-c); and a media content provider (MCP) 812 (e.g., represented by any of remote server computing devices 104a-c).

At block 814, a user logs in to their SNS and receives a media content referral from a friend. Then the user transmits a request for the referred media content 816, 818 to the MCP 812 through the SNS 810, over the Internet 808. Next, at block 820, the MCP 812 processes the referral request to transfer media content. Then the MCP 812 transmits the media content access rules 822 to the PCD 806 over the Internet 808, prior to sending the requested media content. Then at block 824, the user of PCD 806 complies with the media content access rules (e.g., payment rules, referral rules, DRM rules, and/or access restriction rules) that facilitate the user acquiring the requested media content. Then the user of PCD 806 optionally transmits payment in compliance with the access rules 826 over the Internet 808 to the MCP 812 via the SNS 810. Next at block 828, the MCP 812 processes the received payment information (e.g., credit card payment information or gift card information), transmits of the media content, and issues one or more media content access keys (e.g., DRM keys) that facilitate utilization of the media content. Then the MCP 812 optionally transmits the media content and access keys 830 to the PCD 806, over the Internet 808. Then at block 832, the user of the PCD 806 optionally unlocks the received media content with the access keys and then optionally proceeds to forward media content to one or more 834, 836 end playback devices (e.g., PBD1 802 and PBD2 804).

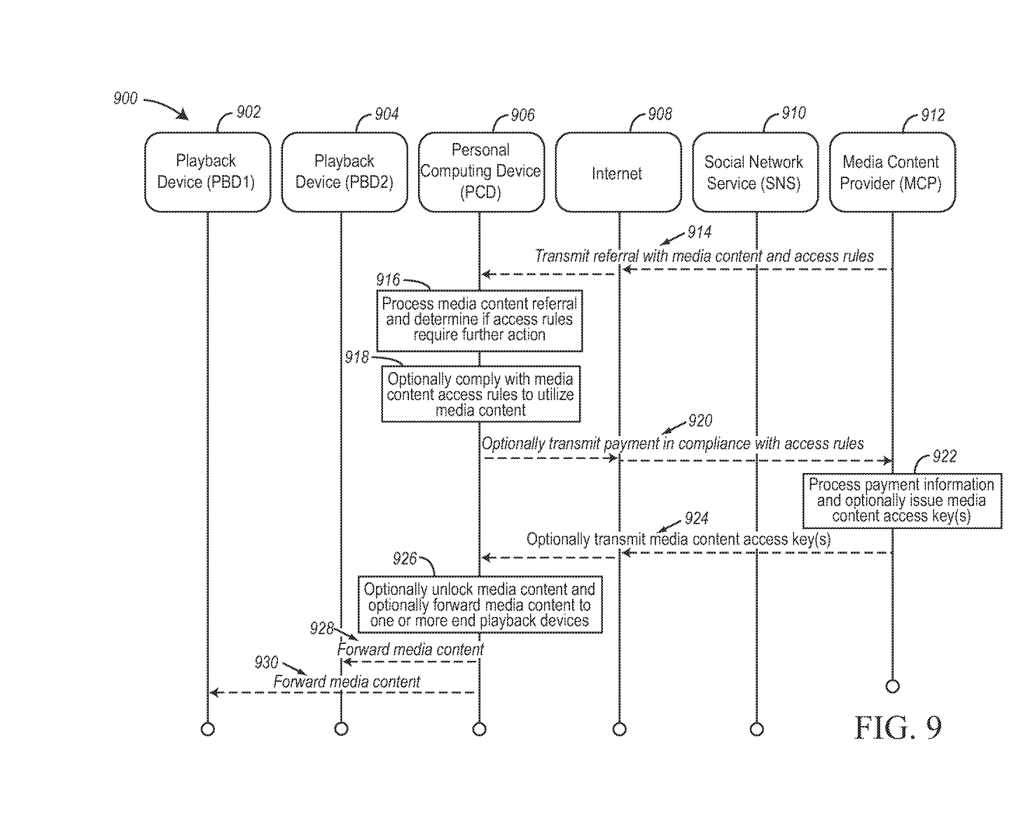

FIG. 9 illustrates a system flow diagram 900 depicting MCP pushed media content delivery, access, and utilization processes associated with an embodiment of the present invention. It should be understood that these processes 900 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., represented by any of remote server devices 104a-c) of FIG. 1. In an embodiment, the system flow diagram 900 depicts data communications interactions amongst at least the following devices: a first playback device (PBD1) 902; a second playback device (PBD2) 904, a personal computing device (PCD) 906; the Internet 908 (e.g., represented by the data communications network 102 of FIG. 1); a social network service (SNS) 910 (e.g., represented by any of remote server computing devices 104a-c); and a media content provider (MCP) 912 (e.g., represented by any of remote server computing devices 104a-c).

Initially a user at a PCD 906 receives a pushed media content and access rules via a media content referral 914 emanating from a MCP 912. Next, at block 916, the PCD 906 processes the media content referral to determine if the access rules require further action. In an embodiment, pushed media content access may be prepaid by a sending entity and therefore readily accessible to a receiving device. Next at block 918, a user at the PCD 906 optionally complies with media content access rules in order to utilize the pushed media content. Then a user at the PCD 906 optionally transmits payment 920 over the Internet 908 to the MCP 912 in accordance with the access rules. Then at block 922, the MCP 912 processes the payment information and optionally issues media content access keys. Next the MCP 912 optionally transmits the purchased media content access keys 924 to the PCD 906, over the Internet 908. Then at block 926, a user at the PCD 906 optionally unlocks the pushed media content with the access keys and then optionally proceeds to forward media content to one or more 928, 930 end playback devices (e.g., PBD1 902 and PBD2 904).

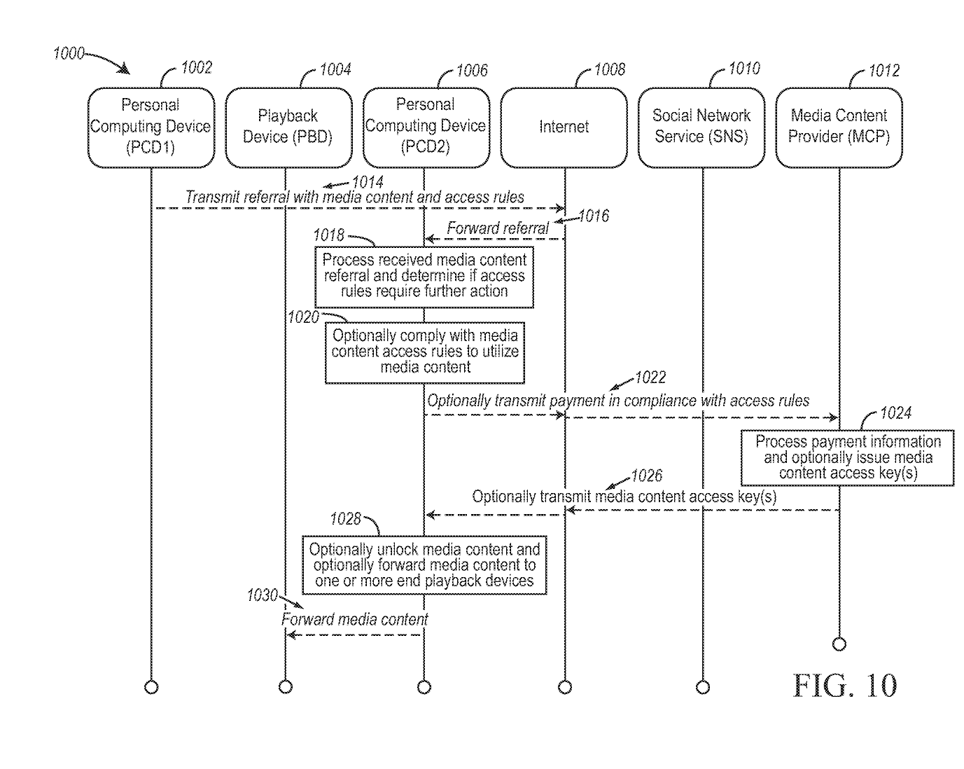

FIG. 10 illustrates a system flow diagram 1000 depicting SNS user pushed media content delivery, access, and utilization processes associated with an embodiment of the present invention. It should be understood that these processes 1000 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., represented by any of remote server devices 104a-c) of FIG. 1. In an embodiment, the system flow diagram 1000 depicts data communications interactions amongst at least the following devices: a first personal computing device (PCD1) 1002; a playback device (PBD) 1004; a second personal computing device (PCD2) 1006, the Internet 1008 (e.g., represented by the data communications network 102 of FIG. 1); a social network service (SNS) 1010 (e.g., represented by any of remote server computing devices 104a-c); and a media content provider (MCP) 1012 (e.g., represented by any of remote server computing devices 104a-c).

Initially a user at PCD2 1006 receives a pushed media content and media content access rules emanating from a user at PCD1 1002 via a media content referral 1014, 1016 over the Internet 1008. Next, at block 1018, the PCD2 1006 processes the media content referral to determine if the access rules require further action. In an embodiment, pushed media content access may be prepaid by a sending entity and therefore readily accessible to a receiving device. Next at block 1020, a user at PCD2 1006 optionally complies with media content access rules in order to utilize the pushed media content. Then a user at PCD2 1006 optionally transmits payment 1022 over the Internet 1008 to the MCP 1012 in accordance with the access rules. Next at block 1024, the MCP 1012 processes the payment information and optionally issues media content access keys. Then the MCP 1012 optionally transmits the purchased media content access keys 1026 to the PCD2 1006, over the Internet 1008. Then at block 1028, a user at PCD2 1006 optionally unlocks the pushed media content with the access keys and then optionally proceeds to forward media content to one or more 1030 end playback devices (e.g., PBD 1004).

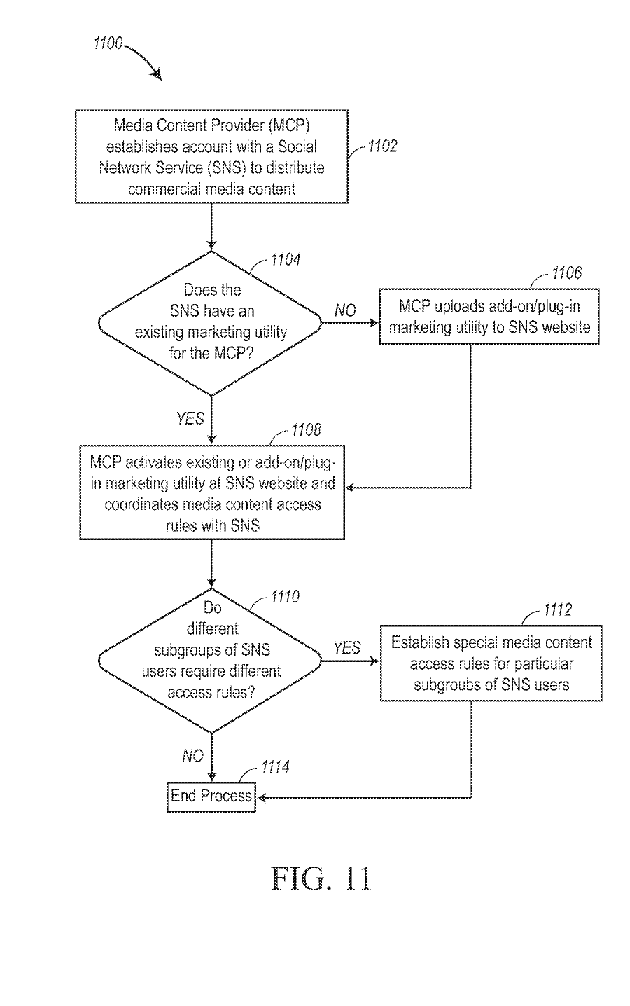

FIG. 11 illustrates a flow diagram 1100 depicting MCP and SNS affiliation and access rules establishment processes associated with an embodiment of the present invention. It should be understood that this process 1100 could be executed using one or more computer executable programs stored on one or more computer-readable media located on any of the wireline or wireless PCDs (108a-b, 110, 114, 116, 118, 120, 124, 126, 128, or 130), SNSes, or MCPs (e.g., any of remote server devices 104a-c) of FIG. 1. At block 1102, a MCP establishes an account with a SNS to facilitate the distribution of commercial media content. Then at decision block 1104 it is determined if the SNS has any existing marketing utility for the MCP (e.g., an affiliated advertisement service that the MCP can utilize to establish commercial media content channels). If it is determined that the SNS does not have any existing marketing utility for the MCP, then at block 1106, the MCP uploads an SNS web service, add-on or plug-in utility to the SNS website in order to allow users SNS users to sign up for their service and to distribute media content via integrated media content channels. Subsequently, the process proceeds to block 1108. However, if it is determined that the SNS does have an existing marketing utility for the MCP, the process proceeds to block 1108. At block 1108, the MCP activates an existing or an add-on/plug-in marketing utility at the SNS website and coordinates media content access rules with a SNS. Then at decision block 1110 it is determined if different subgroups of social network users require different media content access rules (e.g., based on age, content rating preferences, payment plans, SNS community affiliations, etc.). If it is determined that one or more SNS user subgroups require different access rules, then at block 1112, special media content access rules for particular subgroups of SNS users are established. Subsequently the process ends at block 1114. Similarly, if it is determined that one or more SNS user subgroups do not require different access rules the process also ends at block 1114.

FIG. 12 illustrates an interactive Media Content Transfer Manager (e.g., MCTM 410) application interface 1210 displayed as a browser-based add-on component at a MCP website 1200 (e.g., MCP Website 418) in accordance with an embodiment of the present invention. In an embodiment, the MCP website 1200, may include, but is not limited to, a URL address bar 1202 having URL address (e.g., “www.mediasurplus.com/NewReleases”); a menu header 1204 having a “User Information” section that displays the name of a currently logged in user (e.g., “Joe Thomas”); a “Browse Selections” section 1206 showing a listing of various media content genres (e.g., “Action”, “Comedy”, “Drama”, “Horror”, “Sci-Fi”, etc.); a media content display section 1208 showing various media content selections from a particular selected media genre (e.g., “New Releases”); a MCTM application interface 1210 that includes the following components: a media content “Selection” component 1012 that allows a user to select various digital media content files (e.g., movies, television programs, sports broadcasts, radio broadcasts, podcasts, music, video games, e-books, and software) at the MCP 400 to refer to various acquainted SNS users; a “Media Content Referrals” component 1214 that displays a listing of currently selected media content (e.g., the movies “Mary Queen of Scots” and “The Mongol Empire”) to be referred to one or more SNS users (e.g., tier 2 users of SNS 200 of FIG. 2, Bob's friends); a “Referral Recipients” component 1216 that allows a user to select which friends receive media content referrals affiliated with the Media Content Referral component 1214 selections; a “Delivery Priority” component 1218 that allows a user to select a priority level for referred media content (e.g., an order selection for multiple, concurrent referrals); a “Send/Save” selection component 1220 that allows a user to save selected media content referrals for later transmittal by clicking the “Save” button, or to send the referrals immediately by clicking the “Send” Button; and a “More” component 1222 that allows a user to access various other media content referrals and data transfer preferences known in the art. In an embodiment, the MCP 400 website 1200, may also include one or more scroll bars 1224 that facilitate viewing additional portions of the MCP website 1200.

FIG. 13 illustrates an interactive account setup interface displayed at a MCP 400 website 1300 (e.g., MCP Website 418) in accordance with an embodiment of the present invention. In an embodiment, the MCP website 1300, may include, but is not limited to, a URL address bar 1302 having URL address (e.g., “www.Mediasurplus.com/Accountsetup”); an account owner component 1304 having information pertaining to, but not limited to, the name, parent account, password information, etc. associated with a MCP subscriber; an access rules component 1306 having information pertaining to, but not limited to, access rules relating to media payment/billing plans, content restrictions, referral plans, etc.; a device identification component 1308 having information pertaining to, but not limited to, a device serial number, brand, and user assigned alias, etc.; a device capabilities component 1310 having information pertaining to, but not limited to, a device storage capacity, allotted media content storage capacity, battery capacity, DRM profiles, video resolution, etc.; an account status component 1312 having information pertaining to, but not limited to, a logged in user's name, last log-in date, account standing, billing schedule, etc.; and a registered friend component 1314 having information pertaining to, but not limited to, a listing of friends who are similarly signed up as registered users with the same MCP and optionally the same SNS, etc. In an embodiment, the MCP 400 website 1300, may also include one or more scroll bars 1316 that facilitate viewing additional portions of the MCP website 1300.

In accordance with an embodiment, the following scenario would be facilitated by the present invention. A movie is published to a MCP channel and a user having access to that channel through a SNS elects to download the media content their PCD 300 (e.g., any of PCDs 108a-b, 110, 114, 116, 118, 120, 124, 126, 128 or 130 of FIG. 1) using their M™ 310 software The user is part of a SNS community that facilitates media content sharing amongst linked users. The user then decides to recommend the downloaded movie to friends in their SNS community by logging into their SNS/MCP account and posting a referral recommendation for the movie to their SNS community. Because the users of the SNS community have agreed to receive pushed media content from fellow community members the movie is automatically uploaded into the media content libraries (e.g., media content repository 314) of the other SNS community users' PCDs 300.

The other SNS community members then receive a notification that a newly recommended media content has arrived at their respective media content libraries and is available for viewing. After agreeing to pay a fee determined by embedded media content access rules these users can acquire a DRM key to unlock their received media content and then watch the movie on demand. Because the media content has been proactively delivered to their PCDs' media content libraries, playback becomes hassle-free with no worry of network connectivity problems or streaming media content buffering delay. After having purchased and viewed the referred the movie the second tier of SNS friends can then recommend the same movie to even more users (to the movie's owner' friends' friends) in the same manner, and the cycle can repeat indefinitely. In accordance with an embodiment of the invention, the MCP 400 can track the movie's distribution to make sure that the proper payments are made and to assure that any DRM restrictions are satisfied.

In accordance with an embodiment, the following scenario would be facilitated by the present invention. An independent film company (an IFC) completes their latest film and is ready to distribute it to the public. An advertising or marketing agent of the IFC logs in to their commercial SNS/MCP account and utilizes a media content distribution application associated with their commercial account to upload their new film to their SNS channel. Then the IFC sets a number of custom access rules for their film's distribution at one or more SNS accounts. For example, the IFC may decide to allow the first 10,000 media content downloads from their channel to be at no cost to consumers. After 10,000 downloads from the IFC's channel, the price for subsequent SNS users to access and view their film will switch to $2.00 USD per download. Because the IFC's film is rated for general audiences and they wish to have it widely distributed, the IFC may elect to set no access restrictions. This effectively means any SNS users can download the film from the IFC's channel and that any SNS user can also then add the film to their own channel to expand available media content distribution source nodes for the same media content. In this way the IFC can maximize their film's exposure across multiple SNSes.

The MCM 310 and/or the MCTM 410 of a channel owner's (e.g., the IFC) PCD 300 or MCP 400 may be utilized to manage the media content delivery to downstream consumers (distributed amongst various levels of SNS tiers) as well as media content referencing rules between media content channels having the same or different media content. Whenever a consumer within a SNS orders a media content from a friend's channel or a random channel the media content distribution may facilitated by the MCM 310 or MCTM 410 applications of the channel's owner. The delivery may be reported to the owner directly so that the billing is handled according to the rules set by the media content owner. As discussed above, the media content owner can track the distributions to ensure that proper payments are being made and to assure that DRM restrictions are satisfied.

In accordance with an embodiment, the following scenario would be facilitated by the present invention. A user creates an account with a SNS/MCP and then chooses to create a new media content channel integrated within their SNS. The user then sets their media content access rules preferences to only allow linked friends to access their channel. The user then adds two friends to their SNS community, friend1 and friend2. The user decides to upload pictures to their SNS channel and also to add some of their favorite video content from other SNS channels. Friend1 and friend2 are immediately notified (e.g., via an email, SMS notification, or a “tweet”) that the user's channel has been updated with new content. Friend1 elects to visit the user's channel and download some of the pictures and a single recommended movie. Friend2 has its SNS/MCP account preferences set to automatically download anything new on user's channel so all the pictures and the new video content residing at or referenced at the user's channel start downloading to friend2' s PCD when one or more SNS channel communications links become available. Friend2 thoroughly enjoys one of the newly acquired movies and decides to refer it to another friend of his, friend3, who currently does not have a SNS/MCP account. Friend3 follows a referral link to accept the media content referral, and decides to create an account with the SNS/MCP so that they can acquire the recommended movie. After signing up for the SNS/MCP, the media content delivery begins and friend3 receives friend2's favored media content.

In another embodiment a user may be browsing their SSN website when they encounter a link on another user's SNS site which contains a media content channel. The user decides to browse media content within the channel and then elects to place an order for channel advertised media content. Their order is processed by a MCP and it is then delivered to their PCD of choice. Having enjoyed the media content, the user recommends it to another friend via a media content referral. The user creates a recommendation from their SNS/MCP account, which is then sent via email to a group of one or more acquainted users. The users receiving the referrals follow the links in the recommendation emails, which prompt them to set up SNS/MCP accounts (assuming they don't already have accounts) and then allows them to accept the recommendation. The users who accept the recommendation then completes any optionally required billing steps and the media content owner is notified of the purchase. In an embodiment, a user who recommends a media content may elect to pre-pay billing charges for referred media content (e.g., as gift to a SNS friend) or the user may elect to leave it to the recipient to pay if they choose to acquire the referred media content. After billing is complete the media content is delivered.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A networked computing system for distributing digital media content, the networked computing system comprising:
a media content provider (MCP);
a plurality of personal computing devices (PCDs);
a social network service (SNS) having a plurality of registered users; and
a data communications network facilitating data communications amongst the MCP, the plurality of PCDs, and the SNS,
wherein a registered user at a first PCD is able to access media content emanating from the MCP based on a media content referral from a registered user at a second PCD, utilizing the SNS.

2. The networked computing system of claim 1, wherein the SNS operates as an agent for the MCP, such that the MCP can utilize the SNS as a viral marketing tool for various media content.

3. The networked computing system of claim 1, wherein the media content emanating from the MCP is commercial media content that a registered user must pay for in accordance with the terms of a service agreement in order to utilize.

4. The networked computing system of claim 1, wherein the media content emanating from the MCP is selected from the group consisting of: movies, television programs, sports broadcasts, radio broadcasts, podcasts, music, video games, e-books, and software.

5. The networked computing system of claim 1, wherein the registered user at the second PCD pushes media content to the registered user at the first PCD as part of the media content referral.

6. A computer-readable medium encoded with computer-executable instructions for distributing digital media content, which when executed, perform a method comprising:
registering a user at a first personal computing device (PCD) and a user at a second PCD with a social network service (SNS);
transmitting a media content referral from the registered user at the second PCD to the registered user at the first PCD, utilizing the SNS; and
accessing media content emanating from a media content provider (MCP) with the first PCD based on the received media content referral.

7. The computer-readable medium of claim 6, wherein the SNS operates as an agent for the MCP, such that the MCP can utilize the SNS as a viral marketing tool for various media content.

8. The computer-readable medium of claim 6, wherein the media content emanating from the MCP is commercial media content that a registered user must pay for in accordance with the terms of a service agreement in order to utilize.

9. The computer-readable medium of claim 6, wherein the media content emanating from the MCP is selected from the group consisting of: movies, television programs, sports broadcasts, radio broadcasts, podcasts, music, video games, e-books, and software.

10. The computer-readable medium of claim 6, wherein the registered user at the second PCD pushes media content to the registered user at the first PCD as part of the media content referral.

11. A computer-implemented method for distributing digital media content, the method comprising:
registering a user at a first personal computing device (PCD) and a user at a second PCD with a social network service (SNS);
transmitting a media content referral from the registered user at the second PCD to the registered user at the first PCD, utilizing the SNS; and
accessing media content emanating from a media content provider (MCP) with the first PCD based on the received media content referral.

12. The computer-implemented method of claim 11, wherein the SNS operates as an agent for the MCP, such that the MCP can utilize the SNS as a viral marketing tool for various media content.

13. The computer-implemented method of claim 11, wherein the media content emanating from the MCP is commercial media content that a registered user must pay for in accordance with the terms of a service agreement in order to utilize.

14. The computer-implemented method of claim 11, wherein the media content emanating from the MCP is selected from the group consisting of: movies, television programs, sports broadcasts, radio broadcasts, podcasts, music, video games, e-books, and software.

15. The computer-implemented method of claim 11, wherein the registered user at the second PCD transmits media content to the registered user at the first PCD as part of the media content referral.

16. A computer-implemented method for distributing digital media content, the method comprising:
associating a media content provider (MCP) with a social network service (SNS) having a plurality of registered users;
designating media content access rules for media content transmitted to registered users of the SNS; and
distributing media content emanating from the MCP to a first registered user of the SNS based on a media content referral from a second registered user of the SNS.

17. The computer-implemented method of claim 16, wherein the media content emanating from the MCP is commercial media content and the media content access rules are selected from the group consisting of: payment rules, referral rules, DRM rules, and access restriction rules.

18. The computer-implemented method of claim 16, wherein the media content emanating from the MCP is selected from the group consisting of: movies, television programs, sports broadcasts, radio broadcasts, podcasts, music, video games, e-books, and software.

19. The computer-implemented method of claim 16, wherein the distributed media content is accessed by the first registered user of the SNS in accordance with media content payment rules that require social network users to make payment to the MCP prior to utilizing distributed media content.

20. The computer-implemented method of claim 16, wherein the MCP and the SNS collaboratively establish access rules pertaining to particular subsets of registered social network users.
